(19) United States
(12) Patent Application Publication
(10) Pub. No.: US 2017/0337558 A1
(43) Pub. Date: Nov. 23, 2017

(54) METHOD AND SYSTEM FOR VOICE AUTHENTICATED DISTRIBUTION OF PAYMENT CREDENTIALS

(71) Applicant: Mastercard International Incorporated, Purchase, NY (US)

(72) Inventor: Mark David CORRITORI, Katonah, NY (US)

(73) Assignee: Mastercard International Incorporated, Purchase, NY (US)

(21) Appl. No.: 15/586,375

(22) Filed: May 4, 2017

Related U.S. Application Data
(60) Provisional application No. 62/338,844, filed on May 19, 2016.

(51) Int. Cl. G06Q 20/40

(52) U.S. Cl. CPC G06Q 20/40145

(57) ABSTRACT

A method for voice-initiated provisioning of payment credentials includes: storing, in a memory of a computing device, at least payment credentials associated with a transaction account and authentication data; receiving, by an audio receiving device of the computing device, a first voice message; determining, by a first application program of the computing device, that the first voice message corresponds to an instruction; electronically transmitting, by the first application program of the computing device, a second voice message to a second application program of the computing device; authenticating, by the second application program of the computing device, the second voice message based on the stored authentication data; and electronically transmitting, by a transmitting device of the computing device, the payment credentials to a point of sale device.

### FIELD

The present disclosure relates to the voice initiated provisioning of payment credentials from a computing device, specifically the use of multiple application programs on a computing device for the authentication of a voice message to initiate the provisioning of payment credentials to a point of sale device for use in funding a payment transaction.

### BACKGROUND

As voice recognition technology has improved, applications have been developed to provide users of computing devices with assistance in performing basic tasks of the computing device. For example, application programs have been developed to assist users with conducting web searches, setting timers, composing email addresses and short messaging service messages, and converting text to speech for accessibility. Additional information regarding the operation of a computing device using voice commands can be found in U.S. Published Patent Application No. 2016/0119338 AI, entitled “Device Access Using Voice Authentication,” filed on Jan. 4, 2016, which is herein incorporated by reference in its entirety.

In some instances, application programs have been developed to perform authentication of a user based on their voice for use in conjunction with the processing of payment transactions. For example, application programs have been developed to authenticate a user's voice commands in place of a personal identification number or other traditional form of user authentication. More information regarding voice authentication can be found in U.S. Published Patent Application No. 2015/0127475, entitled “Systems and Methods of Voice Authentication in Transactions,” filed on Oct. 31, 2014, and U.S. Pat. No. 8,555,358, entitled “System and Method for Secure Telephone and Computer Transactions Using Voice Authentication,” filed Mar. 7, 2008, which are herein incorporated by reference in their entirety.

However, such programs are often limited to the performing of authentication. In many instances, such application programs are unable to access payment credentials that may be stored on a computing device due to increased security restrictions associated therewith. In such instances, application programs that are configured to access payment credentials may use authentication methods and data separate from application programs configured to provide assistance, in the interest of data security. In these instances, the consumer may have to use several application programs and supply multiple sets of authentication credentials, which may be counter to the use of application programs designed to simply the user experience.

Thus, there is a need for a technological solution to provision payment credentials from a computing device via the use of multiple application programs to provide for the voice-initiated transmission of payment credentials to a point of sale for use in funding a payment transaction though technology that offers advantages over the above-described prior technology.

### SUMMARY

The present disclosure provides a description of systems and methods for the provisioning of payment credentials from a computing device using multiple application programs. The use of multiple application programs may enable an application program configured to provide assistance to the user of a computing device to assist in the provisioning of payment credentials with minimal reconfiguration from legacy configurations, via the use of an additional application program specifically configured to perform authentication and initiate the transmission of payment credentials to a point of sale device.

A method for voice-initiated provisioning of payment credentials includes: storing, in a memory of a computing device, at least payment credentials associated with a transaction account and authentication data; receiving, by an audio receiving device of the computing device, a first voice message; determining, by a first application program of the computing device, that the first voice message corresponds to an instruction; electronically transmitting, by the first application program of the computing device, a second voice message to a second application program of the computing device; authenticating, by the second application program of the computing device, the second voice message based on the stored authentication data; and electronically transmitting, by a transmitting device of the computing device, the payment credentials to a point of sale device.

A system for voice-initiated provisioning of payment credentials includes: a memory of a computing device configured to store at least payment credentials associated with a transaction account and authentication data; an audio receiving device of the computing device configured to receive a first voice message; a first application program of the computing device configured to determine that the first voice message corresponds to an instruction, and transmit a second voice message to a second application program of the computing device; a second application program of the computing device configured to authenticate the second voice message based on the stored authentication data; and a transmitting device of the computing device configured to electronically transmit the payment credentials to a point of sale device.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for provisioning payment credentials to a point of sale device in accordance with exemplary embodiments.

FIG. 2 is a block diagram illustrating the computing device of FIG. 1 for the provisioning of payment credentials to a point of sale device in accordance with exemplary embodiments.

FIG. 3 is a flow diagram illustrating a process for the provisioning of payment credentials to a point of sale device via the use of multiple application programs using the system of FIG. 1 in accordance with exemplary embodiments.

FIG. 4 is a flow diagram illustrating a process for the provisioning of payment credentials via the use of multiple application programs of the computing device of FIG. 2 in accordance with exemplary embodiments.

FIG. 5 is a flow chart illustrating an exemplary method for voice-initiated provisioning of payment credentials in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

### System for Voice-Initiated Provisioning of Payment Credentials

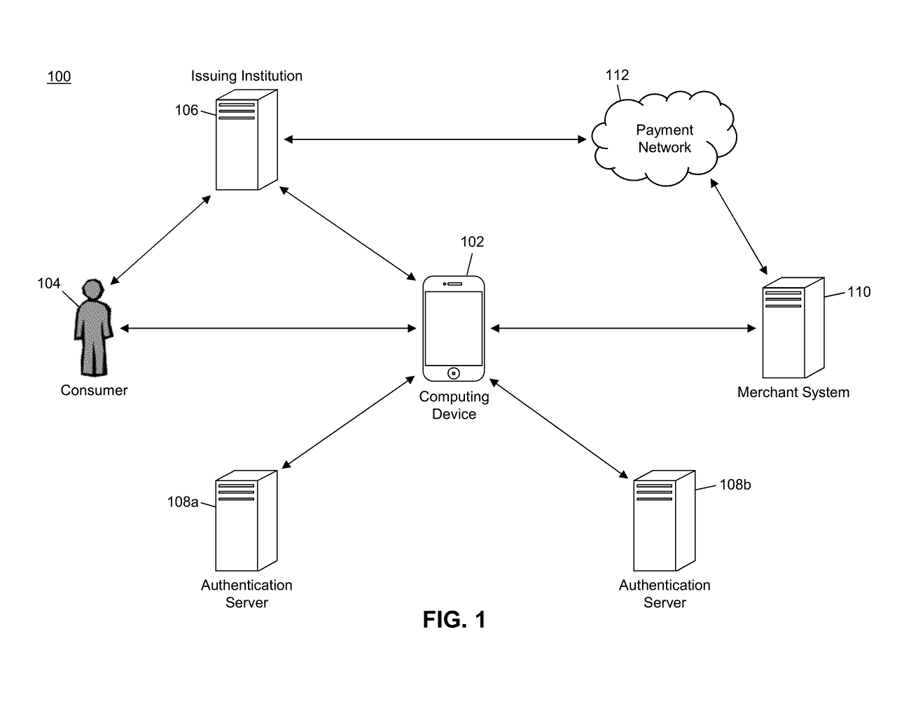

FIG. 1 illustrates a system 100 for the provisioning of payment credentials to a point of sale from a computing device using voice authentication and multiple application programs.

The system 100 may include a computing device 102. The computing device 102, discussed in more detail below, may be configured to provision payment credentials to a merchant point of sale device, where the payment credentials are associated with a transaction account to be used in funding a payment transaction. The computing device 102 may be any type of computing device suitable for conveying payment credentials that may be specially configured to perform the functions disclosed herein, such as a desktop computer, laptop computer, notebook computer, tablet computer, cellular phone, smart phone, smart watch, smart television, wearable computing device, implantable computing device, etc.

The computing device 102 may include at least two application programs configured as discussed herein to enable a consumer 104, as a user of the computing device 102, to initiate the provisioning of payment credentials from the computing device 102 via a voice command recorded and authenticated by the computing device 102. The consumer 102 may be a customer of an issuing institution 106, which may be a financial institution or other suitable type of entity that issues transaction accounts to consumers 102 for use in funding payment transactions, such as an issuing bank. The issuing institution 106 may issue a transaction account to the consumer 104. As part of the issuing of the transaction account, the issuing institution 106 may provide one or more payment instruments to the consumer 104 for use in conveying payment credentials to merchants, other consumers, and other entities as part of payment transactions involving the consumer 104.

In an exemplary embodiment, payment credentials associated with the transaction account issued to the consumer 104 will be provisioned to the computing device 102. The computing device 102 may store the provisioned payment credentials in a memory or other storage included therein for use in performing the functions discussed herein. In some instances, the computing device 102 may store the payment credentials in a secure storage, such as a Secure Element (a tam per-resistant platform such as semiconductor-based chip secure microcontroller, capable of securely hosting applications and their confidential and cryptographic data (e.g. key management) in accordance with the rules and security requirements set forth by a set of well-identified trusted authorities. Methods for the provisioning payment credentials to a computing device 102 for storage therein will be apparent to persons having skill in the relevant art.

The computing device 102 may include at least two application programs. The first application program may be configured to receive and analyze voice messages spoken by the consumer 104 and received via an audio receiving device of the computing device 102, such as a microphone, and may provide the consumer 104 with assistance in operating the computing device 102 based on spoken voice commands. For instance, the first application program may be a personal assistant program configured to assist the consumer 104 in performing Internet searches, setting timers and reminders, composing email messages, etc. For example, the first application program may be Siri by Apple®, Cortana by Microsoft®, Google® Now, etc. The first application program may be prohibited by the computing device 102 (e.g., by the storage, second application program, etc.) from accessing the payment credentials.

The second application program may be configured to receive and analyze voice messages spoken by the consumer 104 and may authenticate the voice messages where successful authentication of the voice message may initiate the electronic transmission of the stored payment credentials to a point of sale device for use in a payment transaction. In some embodiments, the voice message authenticated by the second application program may be provided by the first application program. For instance, the second application program may use an application programming interface (API) whereby the first application program may pass a voice message for authentication and usage by the second application program. In other embodiments, the voice message may be provided to the second application program directly from the audio receiving device.

In some embodiments, one or both of the application programs may use an external authentication server 108 for performing authentication and other determinations regarding received voice messages. For instance, the first application program may electronically transmit a received voice message to a first authentication server 108a. The first authentication server 108a may analyze the voice message to identify the content of the voice message and/or an instruction or action intended to be initiated via the voice message. The first authentication server 108a may then return the instruction or action to the computing device 102. In such embodiments, the first authentication server 108a may assist the first application program in the analysis of voice messages, such as by outsourcing the processing that may be necessary to analyze a voice message. Similarly, the second application program may electronically transmit a received voice message to a second authentication server 108b for analysis. In some instances, the second authentication server 108b may perform the authentication of the voice message, and may return an authentication result to the second application program to initiate the provisioning of payment credentials from the computing device 102.

In some such embodiments, the computing device 102 (e.g., the respective application programs stored and executed thereby) may be configured to encrypt voice messages prior to transmission to authentication servers 108. In such embodiments, the authentication servers 108 may return encrypted data, which may be decrypted by the respective application programs or other suitable programs and modules of the computing device 102.

In some embodiments, a single voice message may be received and analyzed by both the first application program and second application program. For example, the consumer 104 may speak a voice message that is identified by the first application program as an instruction to initiate the provisioning of payment credentials. The voice message may then be provided to the second application program, which may perform authentication of the voice message. In other embodiments, multiple voice messages may be used. For example, the consumer 104 may speak a first voice message that is identified by the first application program as an instruction to initiate the provisioning of payment credentials. The consumer 104 may then be prompted to speak a second voice message to use for authentication, such as a predetermined or a randomly identified authentication phrase. The prompt may be initiated by the first application program (e.g., where the second voice message is then transmitted to the second application program) or by the second application program (e.g., after the first application program notifies the second application program of the instruction). The prompt may be a display prompt, an audio emitted prompt, or other suitable type of prompt. The second application program may then authenticate the second voice message, and, upon successful authentication, provision the payment credentials.

Once the second application program has authenticated a voice message that is predetermined to be an instruction to initiate the provisioning of the payment credentials, the second application program may then initiate the provisioning of the payment credentials from the computing device 102 to a point of sale device. The point of sale device may be part of a merchant system 110, which may be a computing system of a merchant that is configured to initiate payment transactions for processing for the purchase of goods or services. In some instances, the second application program may be configured to provide an instruction to a third application program that is configured to electronically transmit payment credentials, such as an electronic wallet application program. In such instances, the second application may perform authentication and may be configured to provide the necessary data to the electronic wallet to satisfy predetermined criteria for the transmission of the payment credentials accessible thereby. In other instances, the second application program itself may also be configured to perform the functions of an electronic wallet application program.

The computing device 102 may electronically transmit the payment credentials stored therein to the merchant system 110 using a suitable communication network and method, such as via near field communication, radio frequency, local area network, Bluetooth, etc. Methods for the electronic transmission of payment credentials between a computing device 102 and a point of sale device will be apparent to persons having skill in the relevant art. In some embodiments, the payment transaction may be an e-commerce transaction. In such embodiments, the payment credentials may be submitted to the merchant system 110 by the computing device 102 via a web site or other suitable method, where such submission is initiated via the second application program.

The merchant system 110 may receive the payment credentials and may electronically transmit the payment credentials and other transaction data to a payment network 112 for processing. The payment credentials may be comprised of a primary account number and any other data used in the identification, authentication, and confirmation of the transaction account used to fund the payment transaction, such as a name, security code, transaction counter, cryptogram, etc. Other transaction data may include any other data related to the payment transaction that may be used in the processing thereof, such as a transaction amount, transaction time, transaction date, geographic location, merchant name, merchant identification number, merchant category code, issuer data, acquirer data, point of sale data, product data, offer data, reward data, loyalty data, etc. In some embodiments, the merchant system 110 may electronically transmit the transaction data directly to the payment network 112 via payment rails associated therewith. In other embodiments, the merchant system 110 may electronically transmit the transaction data to another entity, such as an acquiring financial institution or gateway processor, for forwarding to the payment network 112 directly or via one or more additional intermediate entities.

In some embodiments, the transaction data may be formatted in a transaction message by the merchant system 110 or an intermediate entity prior to transmission to the payment network 112. A transaction message may be a specially formatted data message that is formatted pursuant to one or more standards governing the exchange of financial transaction messages, such as the International Organization of Standardization's ISO 8583 or ISO 20022 standards. A transaction message may include a message type indicator indicating a type of the transaction message, such as an authorization request or authorization response, and a plurality of data elements, where each data element is configured to store transaction data. In some embodiments, a transaction message may also include one or more bitmaps, which may be configured to indicate the data elements included in the transaction message and the data stored therein.

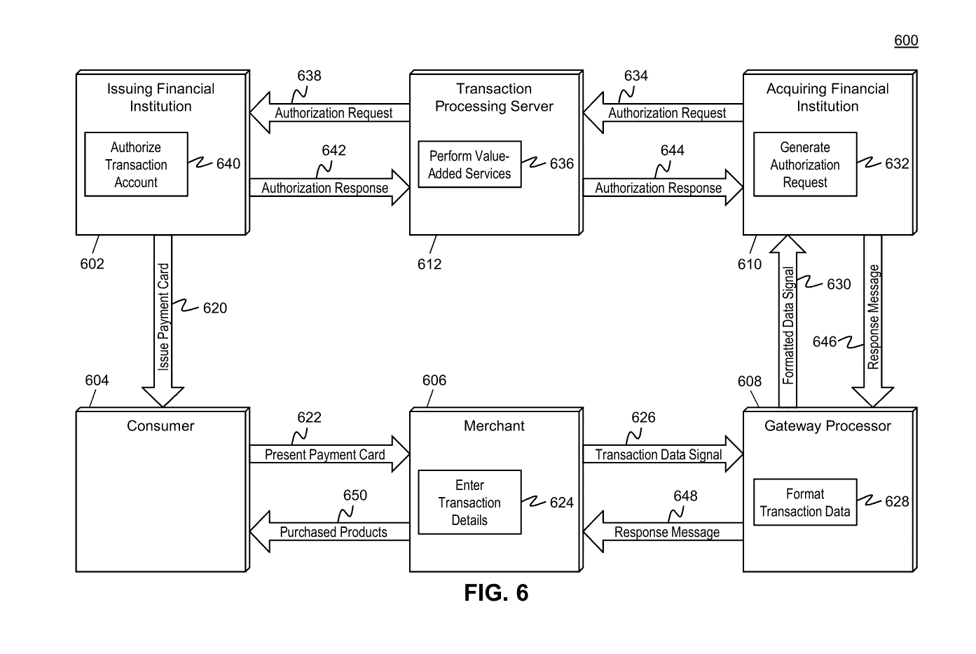

The transaction message for the payment transaction may be submitted to the payment network 112 via payment rails associated therewith. The payment network 112 may then process the payment transaction using traditional methods and systems, which may include forwarding an authorization request to the issuing institution 106 and receiving an authorization response therefrom. Additional information regarding the formatting and use of transaction messages and traditional methods for the processing of payment transactions is discussed in more detail below with respect to the process 600 illustrated in FIG. 6.

In some embodiments, the computing device 102 may be configured to receive and store data regarding processed payment transactions. In such an embodiment, once a payment transaction has been processed, transaction data for the payment transaction may be electronically transmitted to the computing device 102. In one embodiment, the merchant system 110 may electronically transmit a transaction confirmation, digital receipt, or other representation of transaction data for the payment transaction to the computing device 102, such as using the same communication method used in the transfer of the payment credentials. In another embodiment, the issuing institution 106 may electronically transmit the transaction data to the computing device 102 after performing the functions of the issuing institution 106 necessary for the processing of the payment transaction. The computing device 102 may store the transaction data, which may be accessed by the consumer 104, such as to review prior purchases, for use in performing returns, etc. In some cases, the transaction data may be stored in a separate memory from the payment credentials or may otherwise be separated from the payment credentials.

In some such embodiments, the second application program, issuing institution 106, or other entity may be configured to provide additional services to the consumer 104 via the computing device 102 based on the transaction data for processing payment transactions. For example, the consumer 104 may be provided with purchase opportunities, financial incentives, coupons, deals, offers, loyalty programs, etc. based on their spending behavior as may be determined based on transaction data for payment transactions initiated via the computing device 102. In some instances, such additional services may be integrated with the second application program. For example, the consumer 104 may be provided with a discount on a purchase with a specific merchant. The consumer 104 may initiate a payment transaction using their voice and, as part of the process, may provide a voice message configured to instruct the computing device 102 to provide the discount information to the merchant system 110 with the payment credentials.

In some embodiments, the computing device 102 may be configured to use multiple types of authentication. For instance, in addition to performing voice authentication to authenticate voice characteristics and/or content of a voice message, as discussed herein, authentication of the computing device 102 may also be performed. For example, the computing device 102 may be provided with a token or other unique identifying information that may be electronically transmitted to the merchant system 110 with the payment credentials, or that may be used to generate data to be transmitted with the payment credentials, such that the token or generated data may be used to authenticate the computing device 102 as an authorized device for conveying the payment credentials. In such an embodiment, the computing device 102 may be authenticated to ensure that a transaction isn't attempted with a compromised device or with an unauthorized device, for added consumer protection and security. Methods for authenticating a computing device as part of a payment transaction via the use of tokens or subsequently generated data will be apparent to persons having skill in the relevant art.

The methods and systems discussed herein enable a consumer 104 to provide payment credentials to a merchant system 110 for use in a payment transaction as a result of a voice command. The use of multiple application programs by the computing device 102 may ensure that a consumer 104 may continue to use an existing application program, such as an already registered and used personal assistant program, while also being able to use their voice command to initiate the transmission of payment credentials via the second application program. The use of a second application program can ensure the ability for the first application program to be continued to be used by the consumer 104 with minimal modification to legacy systems, such as the first application program's program code or the first authentication server's configuration. In addition, the prohibition of the first application program from accessing the payment credentials may ensure that a high level of consumer security is maintained. The use of both application programs at the same time may also enable the consumer 104 to avail herself of the benefits of the application programs, with only having to regularly interact with the first application program and avoid the use of multiple application programs and authentication and registration schemes, by virtue of the communications between the first and second application programs.

### Computing Device

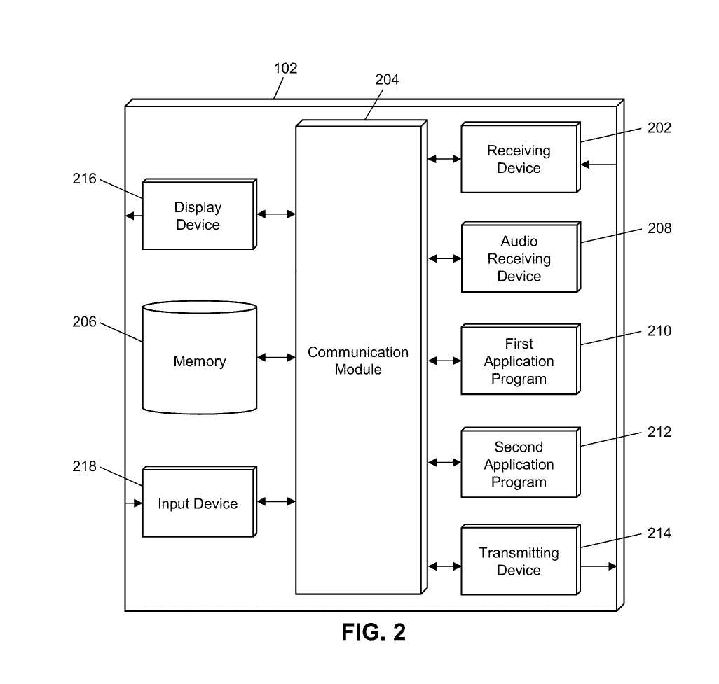

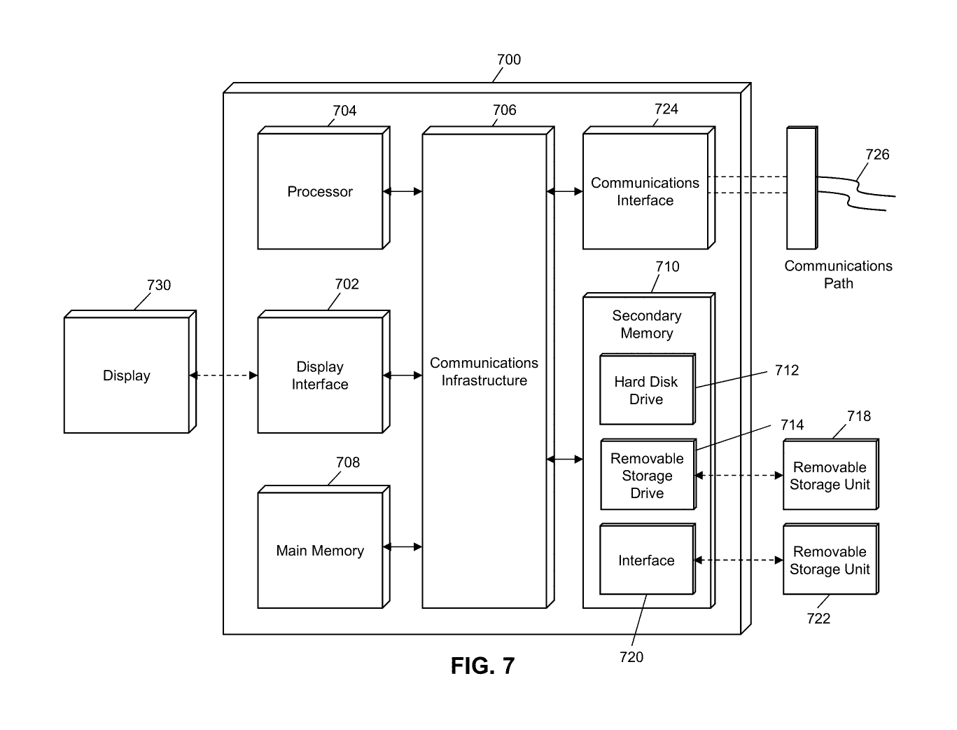

FIG. 2 illustrates an embodiment of the computing device 102 in the system 100. It will be apparent to persons having skill in the relevant art that the embodiment of the computing device 102 illustrated in FIG. 2 is provided as illustration only and may not be exhaustive to all possible configurations of the computing device 102 suitable for performing the functions as discussed herein. For example, the computer system 700 illustrated in FIG. 7 and discussed in more detail below may be a suitable configuration of the computing device 102.

The computing device 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 112 for the transmission of transaction messages that include sensitive financial data and information. In some instances, the receiving device 202 may also be configured to receive data from issuing institutions 102, authentication servers 108, merchant systems 110, payment networks 112, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by issuing institutions 106, which may be superimposed or otherwise encoded with payment credentials that are being provisioned to the computing device 102. The receiving device 202 may also be configured to receive data signals superimposed or otherwise encoded with transaction data for processing payment transactions, such as may be electronically transmitted by the issuing institution 106, merchant system 110, or payment network 112. In some instances, transaction data may be included in a transaction message, which may be formatted pursuant to one or more standards, such as the ISO 8583 or 20022 standards. In some embodiments, the receiving device 202 may also be configured to receive data signals electronically transmitted by authentication servers 108, such as may be superimposed or otherwise encoded with data related to the analysis of voice messages, such as parsed content, instructions, notifications, authentication results, etc.

The computing device 102 may also include a communication module 204. The communication module 204 may be configured to transmit data between modules, engines, databases, memories, and other components of the computing device 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing device 102 and external components of the computing device 102, such as externally connected databases, display devices, input devices, etc. The computing device 102 may also include a processing device. The processing device may be configured to perform the functions of the computing device 102 discussed herein as will be apparent to persons having skill in the relevant art. In some embodiments, the processing device may include and/or be comprised of a plurality of engines and/or modules specially configured to perform one or more functions of the processing device, such as a modules that may comprise a first application program 210 and second application program 212 executed by the processing device, etc. As used herein, the term “module” may be software or hardware particularly programmed to receive an input, perform one or more processes using the input, and provide an output. The input, output, and processes performed by various modules will be apparent to one skilled in the art based upon the present disclosure.

The computing device 102 may include a memory 206. The memory 206 may be configured to store data for use by the computing device 102 in performing the functions discussed herein. The memory 206 may be configured to store data using suitable data formatting methods and schema and may be any suitable type of memory, such as read-only memory, random access memory, etc. The memory 206 may include, for example, encryption keys and algorithms, communication protocols and standards, data formatting standards and protocols, program code for modules and application programs of the processing device, and other data that may be suitable for use by the computing device 102 in the performance of the functions disclosed herein as will be apparent to persons having skill in the relevant art. In some embodiments, the memory 206 may be comprised of or may otherwise include a relational database that utilizes structured query language for the storage, identification, modifying, updating, accessing, etc. of structured data sets stored therein.

The memory 206 may be configured to store payment credentials provisioned to the computing device 102, such as from the issuing institution 106 (e.g., and received by the receiving device 202). In some embodiments, the memory 206 may include a secure storage for use in storing the payment credentials, access to which may be prohibited. For instance, the first application program 210 may be prohibited from accessing storage that includes the payment credentials, whereas the second application program 212 may be allowed access to the payment credentials. The memory 206 may also be configured to store authentication data and other data that may be used in the analysis and performing of functions based on received voice messages.

The computing device 102 may also include an audio receiving device 208. The audio receiving device 208 may be comprised of one or more components that are configured to receive and record voice messages spoken by a user of the computing device 102, such as the consumer 104. The audio receiving device 208 may be comprised of, for instance, a microphone, an analog to digital converter, and other components that may receive and manipulate spoken voice messages for passing to other modules or engines of the computing device 102 for performing of the functions discussed herein. For example, the audio receiving device 208 may receive a voice message that may be electronically transmitted (e.g., via the communication module 204) to the first application program 210 for analysis thereof. In some instances, the audio receiving device 208 may forward all voice messages to the first application program 210. In other instances, the audio receiving device 208 may receive an instruction from another module or engine of the computing device 102 (e.g., the first application program 210 or second application program 210), which may initiate the recording of a voice message, and where the recorded voice message may be electronically transmitted to the module or engine that supplied the instruction.

The computing device 102 may also include at least a first application program 210 and second application program 212. The first application program 210 and second application program 212 may be associated with program code that may be stored in the computing device 102 (e.g., in the memory 206) and executed by the processing device of the computing device 102 for performing specially configured functions that are specifically configured to perform the functions of the computing device 102 discussed herein. The first application program 210 and second application program 212 may be comprised of a number of modules or engines that may be configured to perform generic functions of the computing device 102, such as for the querying of the memory 206 to identify data, as well as specialized modules configured to perform specially configured functions associated with the respective program.

For instance, the first application program 210 and second application program 212 may each include a querying module, which may be configured to execute queries on databases to identify information. The querying module may receive one or more data values or query strings, and may execute a query string based thereon on an indicated database, such as the memory 206, to identify information stored therein. The querying module may then output the identified information to an appropriate engine or module of the computing device 102 as necessary, such as to the respective application program. For example, the querying module of the first application program 210 may be configured to execute a query on the memory 206 to identify an action that matches a received voice message, which may then be executed by the first application program 210, such as an action to instruct the second application program 212 to authenticate the voice message and initiate the transmission of payment credentials.

The second application program 212 may also include an authentication module. The authentication module may be configured to receive data, authenticate the data, and output a result of the authentication to another module or engine of the second application program 212 or the computing device 102. For example, the authentication module may be configured to authenticate a received voice message to authenticate the consumer 104 as a registered user that is authorized to initiate the transmission of payment credentials from the computing device 102 to a merchant system. In some instances, the authentication module may be used in registration of the consumer 104 as a user, where the authentication module may be configured to identify and store the authentication data via a suitable method for registering the consumer 104 for voice recognition. For instance, the consumer 104 may be required to speak a number of predetermined phrases (e.g., captured via the audio receiving device 208), which may provide data to be used by the authentication module in authenticating the voice message intended for use in initiating the transmission of payment credentials. In performing the authentication, the authentication module may use a predetermined phrase (e.g., set by the consumer 104 or second application program 212 prior to or during registration), or may identify a phrase (e.g., randomly generated or identified, identified from a predetermined set of phrases, etc.) that is to be spoken by the consumer 104 for use in authentication.

The computing device 102 may also include a transmitting device 214. The transmitting device 214 may be configured to transmit data over one or more networks via one or more network protocols. For instance, the transmitting device 14 may be configured to transmit data to issuing institutions 106, authentication servers 108, merchant systems 110, and other entities via near field communication, cellular communication, local area networks, and the Internet. In some embodiments, the transmitting device 214 may be comprised of multiple devices, such as different transmitting devices for transmitting data over different networks, such as a first transmitting device for transmitting data over near field communication and a second transmitting device for transmitting data over the Internet. The transmitting device 214 may electronically transmit data signals that have data superimposed that may be parsed by a receiving computing device. In some instances, the transmitting device 214 may include one or more modules for superimposing, encoding, or otherwise formatting data into data signals suitable for transmission.

The transmitting device 214 may be configured to electronically transmit data signals to issuing institutions 106, which may be superimposed or otherwise encoded with data used in the registration of the computing device 102 for the receipt of payment credentials and other transaction data. The transmitting device 214 may also be configured to electronically transmit data signals to merchant systems 110 that are superimposed or otherwise encoded with payment credentials for use in processing payment transactions. In some instances, the transmission of payment credentials may only be initiated by an instruction received from the second application program 212, and may not be initiated by an instruction received from the first application program 210. In some embodiments, the transmitting device 214 may also be configured to electronically transmit data signals to authentication servers 108, which may be superimposed with voice messages and other data for use by the authentication servers 108 in performing authentication, analysis, identification, or other data on the voice messages for use in the functions discussed herein.

The computing device 102 may also include a display device 216. The display device 216 may be comprised of one or more devices configured to display data to a user of the computing device 102, such as the consumer 104. Display devices that may be included in or may comprise the display device 216 may include, for example, a capacitive touch display, liquid crystal display, light emitting diode display, thin film transistor display, cathode ray tube display, rear projection display, etc. In some instances, the display device 216 may be external to the computing device 102 and may be operated via a suitable physical or non-physical (e.g., wireless) connection to the computing device 102. The display device 216 may be configured to display data as instructed by the first application program 210 and second application program 212, such as a prompt for the consumer 104 to speak a voice message for authentication to initiate the transmission of payment credentials to a merchant system 110.

In some embodiments, the computing device 102 may also include an input device 218. The input device 218 may be comprised of one or more devices configured to receive input from a user of the computing device, such as the consumer 104. In some instances, the input device 218 may be comprised of or may include the audio receiving device 208. Additional input devices that may comprise or be included in the input device 218 may include a keyboard, mouse, click wheel, scroll wheel, camera, optical sensor, touch screen, stylus, etc. The input device 218 may be configured to receive input from the user and pass the input to another module or engine of the computing device 102. For instance, the input device 218 may receive instructions and data from the consumer 104 for use in registering the computing device 102 with the issuing institution 106 that may not be suitably captured via the audio receiving device 208.

### Processes for the Voice-Initiated Provisioning of Payment Credentials

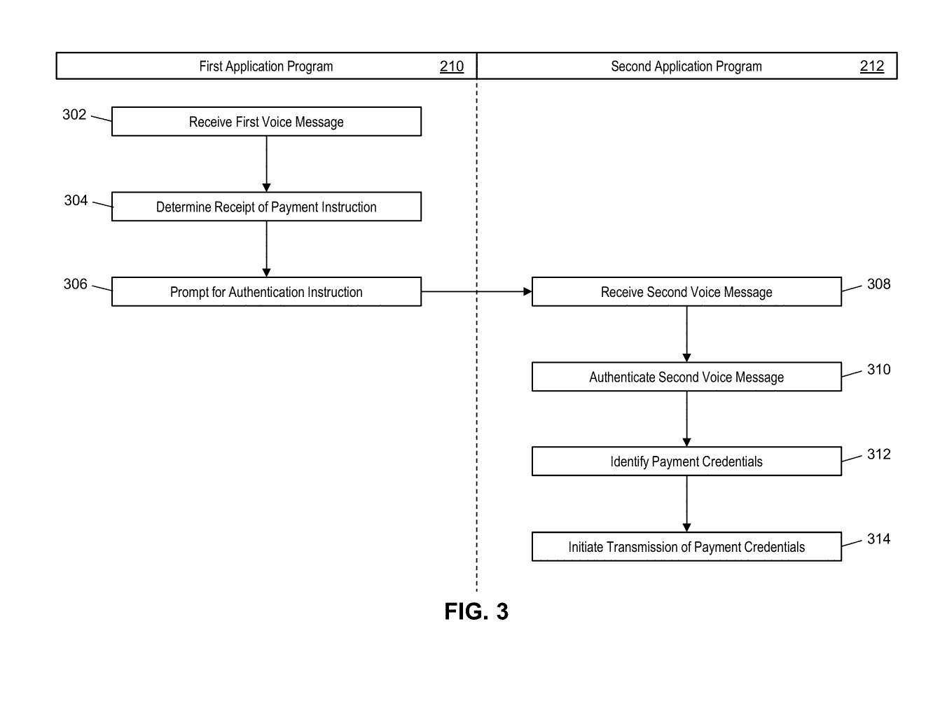

FIG. 3 illustrates a process for the voice initiated provisioning of payment credentials using communications between the first application program 210 and the second application program 212 of the computing device 102.

In step 302, the first application program 210 of the computing device 102 may receive a first voice message. The first voice message may be captured by the audio receiving device 208 of the computing device 102 and may be a voice message spoken by the consumer 104 as a user of the computing device 102. The voice message may be captured and parsed by the audio receiving device 208 and electronically transmitted to the first application program 210 via internal communication methods of the computing device 102, such as via the communication module 204.

In step 304, the first application program 210 may determine that the first voice message is an instruction to initiate the transmission of payment credentials to a merchant system 110 for use in processing a payment transaction. The determination may be based on content of the voice message as analyzed by the first application program 210 and data associated with the first application program 210 and used thereby to identify instructions. For example, the first application program 210 may use prior voice samples provided by the consumer 104 (e.g., during a registration process) to identify words or other audible phrases spoken by the consumer 104 in the voice message, which may then be compared to words or phrases stored in the computing device 102 (e.g., in the memory 206 thereof). The first application program 210 may thus identify that the consumer 102 has spoken a voice message that is designated to initiate the transmission of payment credentials from the computing device 102. For example, the consumer 102 may speak a predetermined phrase of “submit my card information.”

In some embodiments, the first application program 210 may be configured to use an authentication server 108 as part of the determination performed in step 304. In such an embodiment, the first application program 210 may instruct the transmitting device 214 of the computing device 102 to electronically transmit a data signal superimposed or otherwise encoded with at least the first voice message to an authentication server 108. The authentication server 108 may then perform analysis of the voice message and return a result to the computing device 102, to be received via the receiving device 202 of the computing device 102. The result may be the instruction identified based on the content of the voice message, the content of the voice message, or data for use by the first application program 210 in identifying the content or instruction based on the voice message.

In step 306, the first application program 210 may instruct the computing device 102 to prompt the consumer 104 to provide an authentication instruction. The prompt may be displayed by the display device 216 of the computing device 102 or otherwise conveyed to the consumer 104, such as via an audible emission from a speaker of the computing device 102. For instance, the display device 216 may display a prompt requesting the consumer 104 to speak a previously registered authentication phrase or may display a phrase (e.g., identified by the second application program 212, first application program 210, etc.) to be used for authentication. In step 308, the second application program 212 may receive a second voice message, which may include the prompted authentication instruction. The second voice message may be captured by the audio receiving device 208 and communicated directly to the second application program 212 or to the first application program 210 for forwarding to the second application program 212 via the communication module 204. It will be apparent to persons having skill in the relevant art that steps 306 and 308 may be optional steps. For example, in some instances the first voice message may also be used for authentication (e.g., thus serving as the first and second voice messages). In such instances, steps 306 and 308 may be replaced by a step comprising of the electronic transmission of the first voice message to the second application program 212 from the first application program via the communication module 204.

In step 310, the second application program 212 may authenticate the second voice message. The authentication may include the comparison of the second voice message to authentication data stored in the memory 206 of the computing device 102. The authentication data may be comprised of a prior recording of the word(s) and/or phrase(s) included in the second voice message or of other recordings of voice messages by the consumer 104 or data obtained therefrom, which may be used by the second application program 212 in determining that the second voice message was spoken by the consumer 104 as an authorized user. The second application program 212 may, in authenticating the second voice message, authenticate the consumer 104 as the speaker of the voice message. For instance, the second application program 212 may authenticate the speaker based on pitch and other characteristics of the voice message. In some cases, the second application program 212 may also authenticate that the content of the voice message is content specifically configured to initiate the transmission of payment credentials, such as a predetermined phrase. For example, the second voice message may be a predetermined phrase of “I confirm that I want to submit my card information.”

In step 312, the second application program 212 may identify the payment credentials for transmission following authentication of the second voice message. The identification may include the execution of a query on the memory 206 or other secured storage of the computing device 102 to identify the payment credentials stored therein for transmission. In some embodiments, the computing device 102 may be provisioned with multiple sets of payment credentials. In such an embodiment, identification may include the identification of a specific set of payment credentials. The specific set may be a default set, or may be identified by the consumer 104. In some instances, the consumer 104 may identify the set of payment credentials via the input device 218, such as by selecting from a list of usable payment credentials. In other instances, the consumer 104 may provide a voice command that indicates a set of payment credentials, which may be included in the first or second voice message or in a third voice message that may be prompted for and then received by the audio receiving device 208. For instance, the display device 216 may display a list of three potential sets of payment credentials, and the consumer 104 may speak a voice message of “the second card” or “my personal card” or other phrase that may be used to indicate a specific set of payment credentials.

In step 314, the second application program 212 may initiate the electronic transmission of the identified payment credentials. The initiation may include the communication of an instruction to the transmitting device 214 of the computing device 102 to electronically transmit a data signal to a merchant system 110 that is superimposed or otherwise encoded with the identified payment credentials. In some embodiments, the transmitting device 214 may transmit the payment credentials directly to the merchant system 110, such as if the merchant system 110 includes a point of sale device in physical proximity to the computing device 102. In other embodiments, the payment credentials may be transmitted to the merchant system 110 via one or more intermediate computing systems, such as for an e-commerce transaction. For instance, the payment credentials may be submitted to the merchant system 110 via a web page or an additional application program configured to communicate with the merchant system 110. The merchant system 110 may then use the payment credentials in a payment transaction.

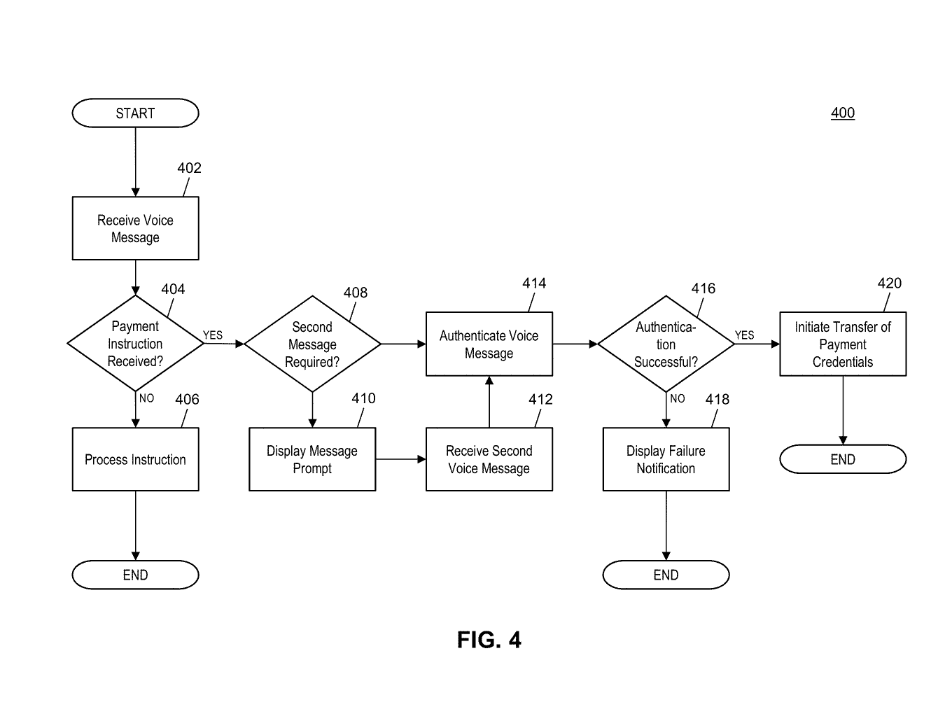

FIG. 4 illustrates a process 400 for the provisioning of payment credentials to a merchant system 100 as executed by the computing device 102 via use of the first application program 210 and second application program 212.

In step 402, the audio receiving device 208 of the computing device 102 may receive a voice message. The voice message may be spoken by the consumer 104 as a user of the computing device 102. The voice message may be forwarded to the first application program 210 of the computing device 102 via the communication module 204. In step 404, the first application program 210 may determine if a payment instruction was received. A payment instruction may be an instruction used to initiate the transmission of payment credentials from the computing device 102. The determination may be based on analysis performed by the first application program 210 of the content of the voice message. In some instances, the first application program 210 may analyze and identify the content of the voice message for comparison of the content to predefined data that is associated with a payment instruction. For instance, the content of the voice message may be analyzed to determine if it matches a predetermined phrase used as a payment instruction.

In some cases, the first application program 210 may use an authentication server 108 as part of the analysis. For instance, the first application program 210 may instruct the transmitting device 214 of the computing device 102 to electronically transmit a data signal to an authentication server 108 superimposed or otherwise encoded with the voice message. The authentication server 108 may analyze the voice message and may respond with a data signal received by the receiving device 202 of the computing device 102 that may be superimposed or otherwise encoded with the content of the voice message or the instruction itself.

If, in step 404, the first application program 210 determines that the voice message is not a payment instruction, then, in step 406, the first application program 210 may process the instruction that comprises the voice message using traditional methods and systems. For example, the voice message may be a request to perform an Internet search. In such an example, the first application program 210 may directly, or using an additional application program, execute an Internet search for the indicated subject matter. If, in step 404, the first application program 210 determines that the voice message is a payment instruction, then the process 400 may proceed to step 408. In step 408, the computing device 102 may determine if a second voice message is required.

The determination may be based on configuration of the second application program 212. For instance, in some embodiments, the second application program 212 may be configured to authenticate the consumer 104 based on characteristics of their voice, without regarding for the content of a voice message. In such an embodiment, the receipt of a second voice message may not be required if the first voice message is suitable for identification of its characteristics, as may be determined by the second application program 212. In other embodiments, the second application program 212 may be configured to also authenticate the payment instruction and/or consumer 104 based on content of a voice message. In such embodiments, the second application program 212 may utilize the first voice message received in step 402, or may require a second voice message.

In latter instances, the process 400 may proceed to step 410 where the second application program 212 may instruct the display device 216 of the computing device 102 to display a message to prompt the consumer 104 to provide a second voice message for authentication. In some cases, the message may include a word or phrase to be spoken by the consumer 104. In other cases, the message may not include any of the word or phrase, which may be previously known to the consumer 104. In step 412, the audio receiving device 208 may receive a second voice message as spoken by the consumer 104.

Once the second voice message has been obtained, or if no second voice message was required (e.g., as determined in step 408), then, in step 414, the second application program 212 may perform authentication of the respective voice message. In some instances, authentication may include only authentication of characteristics of the voice message as matching previously identified voice characteristics of the consumer 104, such as may be stored in authentication data associated with the consumer 104 in the memory 206 of the computing device 102. In other instances, authentication may also include authenticating the content of the respective voice message as matching a predetermined word or phrase designated for authenticating an instruction to initiate transmission of payment credentials.

In some embodiments, the second application program 212 may be configured to perform the authentication directly, such as by identifying the voice characteristics and content of the voice message and comparing the characteristics and content to data stored in the memory 206 of the computing device 102. In other embodiments, the second application program 212 may instruct the transmitting device 214 to electronically transmit a data signal to an authorization server 108 that is superimposed or otherwise encoded with at least the voice message. The authentication server 108 may then analyze and/or authenticate the voice message, and return a data signal to be received by the receiving device 202 of the computing device 102 that is superimposed with the voice characteristics and, if applicable, content of the voice message, and/or a result of the authentication. The second application program 212 may then process the received data accordingly. In embodiments where both the first application program 210 and second application program 212 use an authentication server 108, the respective authentication servers 108 may be separate, or may be the same authentication server 108.

In step 416, the second application program 212 may determine if the authentication was successful. The determination may be based on an authentication result either provided by the authentication module of the second application program 212 or as received from the authentication server 108 used to authentication the voice message, as applicable. If the authentication is not successful, such as because the voice characteristics did not match an authorized user or the content of the voice message was incorrect, then, in step 418, the second application program 212 may instruct the display device 216 to display a failure notification indicating that the authentication failed. In some instances, the notification may provide a reason for the consumer 104, such as by stating that the authentication of voice characteristics failed or that the voice message did not include the proper content. The process 400 may then be completed. In some cases, the consumer 104 may be able to repeat the voice message and authentication reattempted, which may return the process to step 414 once a new voice message has been captured by the audio receiving device 208.

If, in step 416, the second application program 212 determines that the authentication of the voice message was successful, then, in step 420, the second application program 212 may initiate the transfer of payment credentials. The second application program 212 may execute a query on the secured storage of the memory 206 of the computing device 102 to identify the payment credentials stored therein, and may instruct the transmitting device 214 to electronically transmit a data signal to the merchant system 110 (e.g., or other associated program or system) that is superimposed or otherwise encoded with at least the payment credentials. The merchant system 100 may then initiate a payment transaction using the provided payment credentials.

### Exemplary Method for Voice-Initiated Provisioning of Payment Credentials

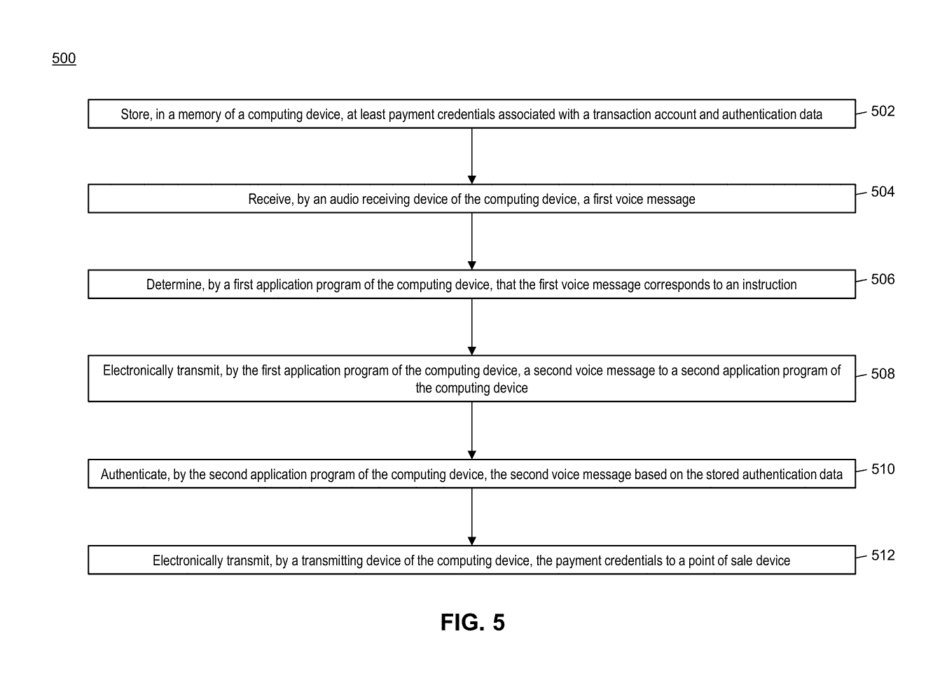

FIG. 5 illustrates a method 500 for the voice-initiated provisioning of payment credentials, specifically the transmission of payment credentials from a computing device initiated by a voice message via the use of multiple application programs executed thereby.

In step 502, payment credentials associated with a transaction account and authentication data may be stored in a memory (e.g., the memory 206) of a computing device (e.g., the computing device 102). In step 504, a first voice message may be received by an audio receiving device (e.g., the audio receiving device 208) of the computing device. In step 506, a first application program (e.g., the first application program 210) of the computing device may determine that the first voice message corresponds to an instruction.

In step 508, a second voice message may be electronically transmitted by the first application program of the computing device to a second application program (e.g., the second application program 212) of the computing device. In step 510, the second application program of the computing device may authenticate the second voice message based on the stored authentication data. In step 512, the payment credentials may be electronically transmitted by a transmitting device (e.g., the transmitting device 214) of the computing device to a point of sale device.

In one embodiment, the first voice message and the second voice message may comprise a single voice message. In other embodiments, the method 500 may further include receiving, by the audio receiving device of the computing device, the second voice message after the determination that the first voice message corresponds to an instruction. In some embodiments, the first application program of the computing device may be configured to cause a display device (e.g., the display device 216) of the computing device to display a prompt prior to receiving the second voice message.

In one embodiment, the instruction may be stored in the memory of the computing device. In some embodiments, the memory of the computing device may be further configured to store program code associated with the first application program and the second application program. In one embodiment, determining that the first voice message corresponds to an instruction may comprise: transmitting, by the transmitting device of the computing device, the first voice message to a first authentication server (e.g., authentication server 108a); and receiving, by a receiving device (e.g., the receiving device 202) of the computing device, the determination from the first authentication server.

In some embodiments, authenticating the second voice message may comprise: transmitting, by the transmitting device of the computing device, at least the second voice message to a second authentication server (e.g., authentication server 108b); and receiving, by the receiving device of the computing device, a result of authentication from the second authentication server. In a further embodiment, the transmission to the second authentication server may further include the authentication data. In another further embodiment, the second authentication server may store the authentication data.

### Payment Transaction Processing System and Process

FIG. 6 illustrates a transaction processing system and a process 600 for the processing of payment transactions in the system, which may include the processing of thousands, millions, or even billions of transactions during a given period (e.g., hourly, daily, weekly, etc.). The process 600 and steps included therein may be performed by one or more components of the system 100 discussed above, such as the computing device 102, consumer 104, issuing institution 106, merchant system 110, payment network 112, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3-5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 660, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the computing device 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for voice-initiated provisioning of payment credentials. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for voice-initiated provisioning of payment credentials, comprising:
storing, in a memory of a computing device, at least payment credentials associated with a transaction account and authentication data;
receiving, by an audio receiving device of the computing device, a first voice message;
determining, by a first application program of the computing device, that the first voice message corresponds to an instruction;
electronically transmitting, by the first application program of the computing device, a second voice message to a second application program of the computing device;
authenticating, by the second application program of the computing device, the second voice message based on the stored authentication data; and
electronically transmitting, by a transmitting device of the computing device, the payment credentials to a point of sale device.

2. The method of claim 1, wherein the first voice message and the second voice message comprise a single voice message.

3. The method of claim 1, further comprising:
receiving, by the audio receiving device of the computing device, the second voice message after the determination that the first voice message corresponds to an instruction.

4. The method of claim 1, wherein the first application program of the computing device is configured to cause a display device of the computing device to display a prompt prior to receiving the second voice message.

5. The method of claim 1, wherein the instruction is stored in the memory of the computing device.

6. The method of claim 1, wherein the memory of the computing device is further configured to store program code associated with the first application program and the second application program.

7. The method of claim 1, wherein determining that the first voice message corresponds to an instruction comprises:
transmitting, by the transmitting device of the computing device, the first voice message to a first authentication server; and
receiving, by a receiving device of the computing device, the determination from the first authentication server.

8. The method of claim 1, wherein authenticating the second voice message comprises:
transmitting, by the transmitting device of the computing device, at least the second voice message to a second authentication server; and
receiving, by a receiving device of the computing device, a result of authentication from the second authentication server.

9. The method of claim 8, wherein the transmission to the second authentication server further includes the authentication data.

10. The method of claim 8, wherein the second authentication server stores the authentication data.

11. A system for voice-initiated provisioning of payment credentials, comprising:
a memory of a computing device configured to store at least payment credentials associated with a transaction account and authentication data;
an audio receiving device of the computing device configured to receive a first voice message;
a first application program of the computing device configured to
determine that the first voice message corresponds to an instruction, and
transmit a second voice message to a second application program of the computing device;
a second application program of the computing device configured to authenticate the second voice message based on the stored authentication data; and
a transmitting device of the computing device configured to electronically transmit the payment credentials to a point of sale device.

12. The system of claim 11, wherein the first voice message and the second voice message comprise a single voice message.

13. The system of claim 11, wherein the audio receiving device of the computing device is further configured to receive the second voice message after the determination that the first voice message corresponds to an instruction.

14. The system of claim 11, wherein the first application program of the computing device is configured to cause a display device of the computing device to display a prompt prior to receiving the second voice message.

15. The system of claim 11, wherein the instruction is stored in the memory of the computing device.

16. The system of claim 11, wherein the memory of the computing device is further configured to store program code associated with the first application program and the second application program.

17. The system of claim 11, wherein determining that the first voice message corresponds to an instruction comprises:
transmitting, by the transmitting device of the computing device, the first voice message to a first authentication server; and
receiving, by a receiving device of the computing device, the determination from the first authentication server.

18. The system of claim 11, wherein authenticating the second voice message comprises:
transmitting, by the transmitting device of the computing device, at least the second voice message to a second authentication server; and
receiving, by a receiving device of the computing device, a result of authentication from the second authentication server.

19. The system of claim 18, wherein the transmission to the second authentication server further includes the authentication data.

20. The system of claim 18, wherein the second authentication server stores the authentication data.
